(19) United States
(12) Patent Application Publication
(10) Pub. No.: US 2014/0244576 A1
(43) Pub. Date: Aug. 28, 2014

(54) SYSTEM CAPABLE OF PROVIDING MULTIPLE DIGITAL CONTENTS AND METHOD USING THE SYSTEM

(71) Applicant: DeNA Co., Ltd., Tokyo (JP)

(72) Inventors: Shinya MASUDA, Tokyo (JP); Tomoyuki SHIMADA, Tokyo (JP)

(73) Assignee: DeNA Co., Ltd., Tokyo (JP)

(21) Appl. No.: 14/187,599

(22) Filed: Feb. 24, 2014

(30) Foreign Application Priority Data
Feb. 27, 2013 (JP) 2013-036897

(51) Int. Cl. G06F 17/30

(52) U.S. Cl. CPC G06F 17/30554
USPC 707/609; 707/722

(57) ABSTRACT

The preferences of users using various contents are properly estimated. A system according to one embodiment includes a service control unit for controlling a whole service for providing digital contents, an information storage device, a determination unit for determining a user satisfying a predetermined condition concerning a usage history of musical pieces of the same artist to be a fan of that artist, a user information updating unit for storing a determination result in the information storage device, a posting accepting unit for accepting a post from a terminal device and storing the post in the information storage device, a feed information transmitting unit for extracting and transmitting feed information, and a recommended user information transmitting unit for choosing recommended users from other users determined to be fans of an artist of whom the user has been determined as a fan and transmitting information about the recommended users.

### CROSS-REFERENCE TO RELATED APPLICATIONS

This application is based on and claims the benefit of priority from Japanese Patent Application Serial No. 2013-036897 (filed on Feb. 27, 2013), the contents of which are hereby incorporated by reference in their entirety.

### TECHNICAL FIELD

The present invention relates to a system and a method using the system and, in particular, to a system that is connected through a communication network to a plurality of terminal devices operated by a plurality of users and is capable of providing a plurality of digital contents to the users, and a method using the system.

### BACKGROUND

A system of this type has been proposed that provides digital contents such as musical pieces, videos, games and electronic books and estimates the preferences of users on the basis of users' content usage patterns (for example, see Japanese Patent Application Laid-Open No. 2012-118705). The system records the amounts of display time of digital contents (electronic books) and compiles statistics based on the amounts of display time to estimate the preferences of users so that contents that match the preferences can be proposed to the users.

### SUMMARY

However, as the variety of contents increases, it becomes increasingly difficult to estimate the preferences of users based on contents usage patterns with a high degree of accuracy. Specifically, as the variety of contents used by users increases, a user's contents usage is diversified over various contents, which makes it difficult to estimate the user's preference for a particular content immediately from the user's usage pattern. Therefore, there is a demand for a mechanism capable of properly estimating the preferences of users in circumstances where the users use a wide variety of contents.

One of the objects of the present invention is to properly estimate users' preferences for contents in circumstances where the users use a wide variety of contents. Other objects of the present invention will be apparent from the following description.

A system according to one embodiment of the present invention is connected through a communication network to a plurality of terminal devices each operated by a respective user and is capable of providing a plurality of digital contents to the users. The system includes an information storage device configured to store at least user information concerning the users, including a history of usage of the digital contents by each of the users, and digital content information concerning the digital contents including classification information for classifying the digital contents, and one or more processors capable of executing a predetermined program. The predetermined program includes a determination module configured to determine a user satisfying a predetermined condition concerning the history of usage of one or more digital contents classified under a same piece of the classification information, to be a specific user for the piece of the classification information, and a user information updating module configured to store a determination result made by the determination module in the information storage device as a part of the user information.

A system according to one embodiment of the present invention is connected through a communication network to a plurality of terminal devices each operated by a respective user and is capable of providing a plurality of digital contents to the users. The system includes an information storage unit configured to store at least user information concerning the users, including a history of usage of the digital contents by each of the users, and digital content information concerning the digital contents including classification information for classifying the digital contents, a determination unit configured to determine a user satisfying a predetermined condition concerning the history of usage of one or more digital contents classified under a same piece of the classification information, to be a specific user for the piece of the classification information, and a user information updating unit configured to store a determination result made by the determination unit in the information storage unit as a part of the user information.

A method according to one embodiment of the present invention is a method for providing a plurality of digital contents to a plurality of users by using a system that is connected through a communication network to a plurality of terminal devices each operated by respective one of the plurality of users and includes an information storage device for storing information. The method involves: storing, in the information storage device, at least user information concerning the users, including a history of usage of the digital contents by each of the users, and digital content information concerning the digital contents including classification information for classifying the digital contents; determining a user satisfying a predetermined condition concerning the history of usage of one or more digital contents classified under a same piece of the classification information, to be a specific user for the piece of the classification information; and storing the determination result in the information storage device as a part of the user information.

Various embodiments of the present invention enable the preferences of users to be properly estimated in circumstances where the users use a wide variety of contents.

### BRIEF DESCRIPTION OF THE DRAWINGS

FIG. 1 is a block diagram schematically illustrating a network configuration including a system according to one embodiment of the present invention;

FIG. 2 is a block diagram schematically illustrating an architecture of a terminal device in one embodiment

FIG. 3 is a block diagram illustrating functions of a system according to one embodiment

FIG. 4 is a diagram illustrating an exemplary usage history management table in one embodiment

FIG. 5 is a diagram illustrating an exemplary fan management table in one embodiment

FIG. 6 is a diagram illustrating an exemplary musical piece management table in one embodiment

FIG. 7 is a diagram illustrating an exemplary feed information management table in one embodiment;

FIG. 8 is a diagram illustrating an exemplary follow information management table in one embodiment;

FIG. 9 is a flowchart illustrating an exemplary posting accepting process in one embodiment

FIG. 10 is a diagram illustrating an exemplary posting accepting screen in one embodiment

FIG. 11 is a flowchart illustrating an exemplary fan determination process in one embodiment

FIG. 12 is a flowchart illustrating an exemplary feed information transmission process in one embodiment

FIG. 13 is a diagram illustrating one display mode of a main screen in one embodiment

FIG. 14 is a diagram illustrating an exemplary music playback screen in one embodiment

FIG. 15 is a flowchart illustrating an example of recommended user information transmission process in one embodiment and

FIG. 16 is a diagram illustrating one display mode of a main screen in one embodiment.

### DESCRIPTION OF THE PREFERRED EMBODIMENTS

Various embodiments of the present invention will be described hereinafter with reference to the drawings. In the drawings, the same components are denoted by the same reference numerals.

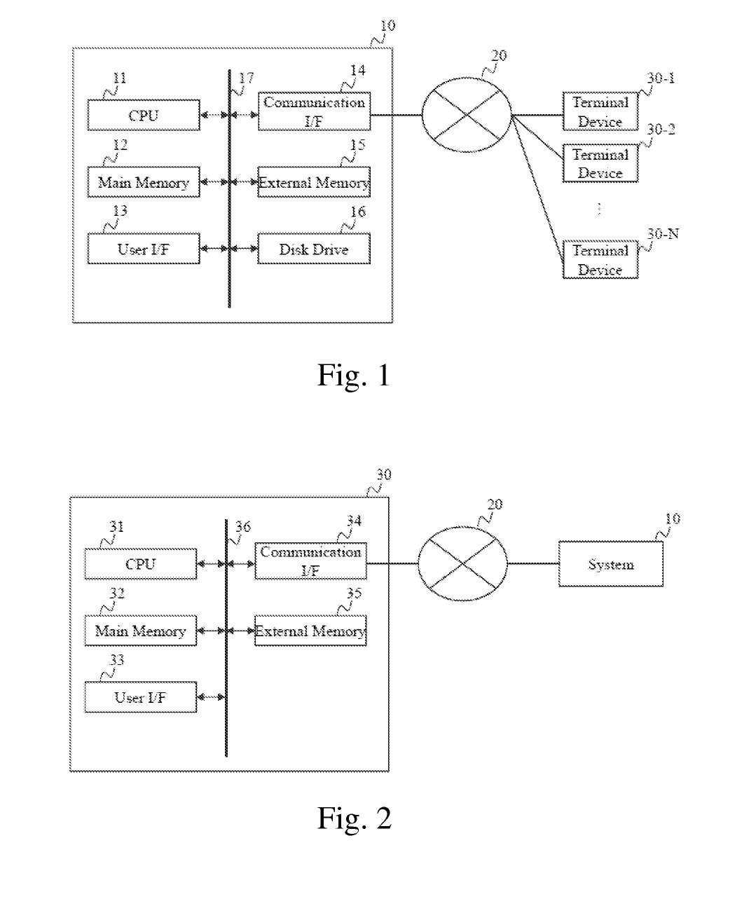

FIG. 1 is a block diagram schematically illustrating a network configuration including a system 10 according to an embodiment of the present invention. As illustrated in FIG. 1, the system 10 according to an embodiment may be communicatively connected to a plurality of terminal devices 30-1, 30-2, . . . , and 30-N (hereinafter also collectively referred to as the “terminal devices 30”), each having a communication function, via a communication network 20 such as the Internet. The system 10 may provide users operating the terminal devices 30 with various digital contents such as musical pieces, videos, electronic books, and games.

As illustrated in FIG. 1, the system 10 according to an embodiment may include a central processing unit (CPU) (processor) 11, a main memory 12, a user interface (I/F) 13, a communication I/F 14, an external memory 15, and a disk drive 16, and these components may be electrically connected to one another via a bus 17. The CPU 11 may load an operating system and various programs into the main memory 12 from the external memory 15, and may execute commands included in the loaded programs. The main memory 12 may be used to store a program to be executed by the CPU 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminal devices 30 via the communication network 20.

The external memory 15 may be formed of, for example, a magnetic disk drive and store a control program for controlling provision services of digital contents. The external memory 15 may also store various data used in the provision services of various digital contents. The various data that may be stored in the external memory 15 may also be stored on a database server communicatively connected to the system 10 and physically separate from the system 10. The disk drive 16 may read data stored in a storage medium such as a compact disc read only memory (CD-ROM), digital versatile disc read only memory (DVD-ROM), or DVD Recordable (DVD-R) disc, or write data to such a storage medium. For example, applications stored in a storage medium and various data for use in provision of the digital contents may be read by the disk drive 16, and may be installed into the external memory 15.

In an embodiment, the system 10 may be a web server for managing a web site including a plurality of hierarchical web pages and may be capable of providing the terminal devices 30 with various digital contents. The terminal devices 30 may fetch HTML data for rendering a web page from the system 10 and analyze the fetched HTML data to present the web page to a user of the terminal devices 30. The HTML data for rendering the web page may also be stored on the external memory 15. The HTML data may comprise HTML documents written in markup languages such as HTML; the HTML documents may be associated with various images. Additionally, the HTML documents may include programs written in script languages such as ActionScript™ and JavaScript™.

The external memory 15 may store applications to be executed on execution environments of the terminal device 30 other than browser software. These applications may include programs for receiving provision services of digital contents and various data such as image data to be referred to for executing the programs. The programs may be created in, for example, object oriented languages such as Objective-C™ and Java™. The created programs may be stored on the external memory 15 in the form of application software along with various data. The application software stored on the external memory 15 may be delivered to a terminal device 30 in response to a delivery request. The application software may not necessarily be directly delivered from the system 10 but may be delivered via another system or server communicatively connected to the system 10 and the terminal device 30. The application software delivered from the system 10 may be received by the terminal device 30 through a communication I/F 34 in accordance with the control of CPU 31; the received programs may be sent to an external memory 35 and stored thereon. The application software may be launched in accordance with the user's operation on the terminal device 30 and may be executed on an execution environment implemented on the terminal device 30 such as NgCore™ or Android™. The system 10 may provide the applications executed on the terminal devices 30 with various data required for provision services of digital contents. Additionally, the system 10 can store various data sent from the terminal device 30 for each user, thereby managing the state of provided digital contents (e.g., playback of the musical pieces and videos and the progression of the games) for each user.

Thus, the system 10 may manage the web site for providing various digital contents and deliver web pages constituting the web site in response to a request from the terminal device 30, thereby providing digital contents to a user. Also, the system 10 can provide digital contents based on communication with an application performed on the terminal device 30 in place of, or in addition to, such browser-based provision services of digital contents. Whichever mode may be taken to provide the digital contents, the system 10 can store data required for the provision services of digital contents for each identification identifying a user. Briefly, the system 10 may also include a function to authenticate a user at start of the provision services of digital contents and perform charging process in accordance with provision of digital contents.

In an embodiment, the terminal device 30 may be any information processing device that may display on a web browser a web page of a web site for the provision services of digital contents obtained from the system 10 and include an executing environment for executing applications.

The architecture of the terminal device 30 will now be described with reference to FIG. 2. FIG. 2 is a block diagram schematically illustrating the architecture of a terminal device 30. As illustrated in FIG. 2, the terminal device 30 may include a central processing unit (CPU) 31, a main memory 32, a user interface (I/F) 33, a communication I/F 34, and an external memory 35, and these components may be electrically connected to one another via a bus 36.

The CPU 31 may load various programs such as an operating system into the main memory 32 from the external memory 35, and may execute commands included in the loaded programs. The main memory 32 may be used to store a program to be executed by the CPU 31, and may be formed of, for example, a dynamic random access memory (DRAM).

The user I/F 33 may include, for example, an information input device such as a touch panel, a keyboard, a button, and a mouse for accepting an input from a user, and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the system 10 via the communication network 20.

The external memory 35 may comprise, for example, a magnetic disk drive or a flash memory and store various programs such as an operating system. When receiving an application from a system 10 via the communication I/F 34, the external memory 35 may store the received application.

A terminal device 30 having such an architecture may include, for example, browser software for interpreting an HTML file (HTML data) and rendering a screen; this browser software may enable the terminal device 30 to interpret the HTML data fetched from the system 10 and render web pages corresponding to the received HTML data. Further, the terminal device 30 may include plug-in software (e.g., Flash Player distributed by Adobe Systems Incorporated) embedded into browser software; therefore, the terminal device 30 can fetch from the system 10 a SWF file embedded in HTML data and execute the SWF file by using the browser software and the plug-in software.

When a provision service of digital contents is received on the terminal device 30, for example, animation or an operation icon designated by the program may be displayed on a screen of the terminal device 30. The user may enter an instruction for receiving the provision service of digital contents using an input interface of the terminal device 30. The instruction entered by the user may be transmitted to the system 10 through the browser of the terminal device 30 or a function of an execution environment such as NgCore™.

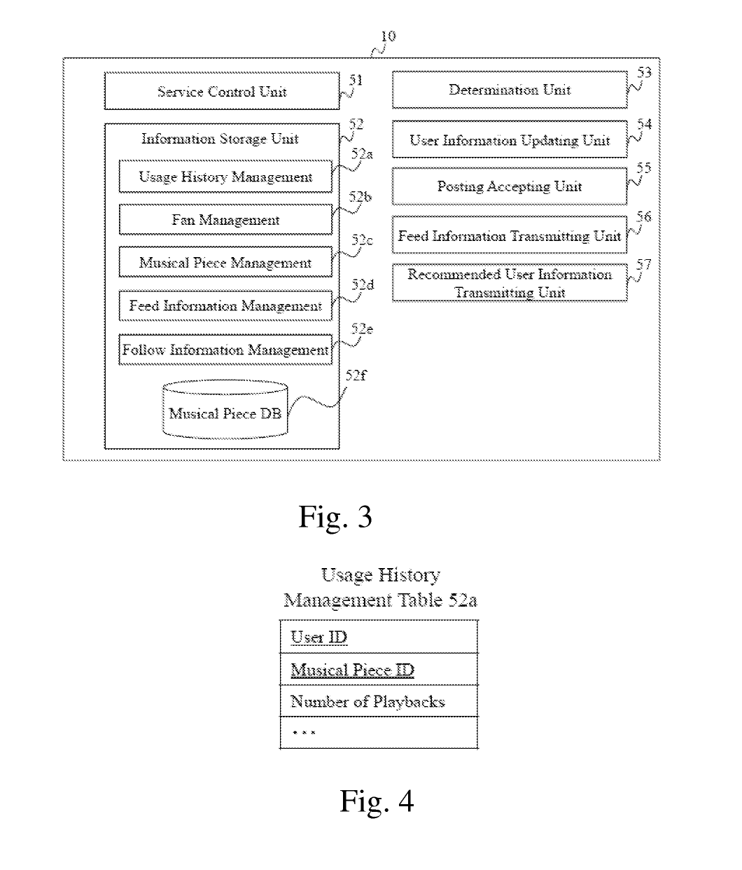

Functions of the system 10 implemented by the components illustrated in FIG. 1 will now be described. While the system 10 is capable of providing a wide variety of digital contents as stated above, functions relating to a music distribution service will be primarily described as an example suitable for illustrating an embodiment of the present invention. FIG. 3 is a block diagram illustrating the functions of the system 10 according to one embodiment of the present invention. As depicted, the system 10 may include a service control unit 51 for controlling an entire digital content distribution service, an information storage unit 52 for storing information, a determination unit 53 for determining a user who satisfies a predetermined condition concerning a history of usage of one or more musical pieces (digital contents) of the same artist (classification information) to be a fan (specific user) of that artist, a user information updating unit 54 for storing the determination result made by the determination unit 53 in the information storage unit 52, a posting accepting unit 55 for accepting a post (a display content) from a terminal device 30 and storing the post in the information storage unit 52 in association with a user operating the terminal device 30, a feed information transmitting unit 56 for extracting feed information (posts and articles) and transmitting the feed information to the terminal device 30, and a recommended user information transmitting unit 57 which chooses some or all of the users determined to be fans of the same artist as the artist of whom the user has been determined to be a fan as recommended users to be recommended to the user and transmits information about the recommended users to the terminal device 30. These functions may be implemented by the CPU 11 and programs and tables stored in the main memory 12 and the external memory 15 operating in coordination with one another. For example, the functions may be implemented by the CPU 11 executing a program including modules corresponding to the functions of the determination unit 53, the user information updating unit 54, the posting accepting unit 55, the feed information transmitting unit 56, and the recommended user information transmitting unit 57.

The service control unit 51 can transmit and receive various kinds of data required for digital content providing service to and from terminal devices 30 and can manage the data on a user-by-user basis to control the digital content providing service on a user-by-user basis. For example, the service control unit 51 may display web pages constituting a web site that provides a service on a terminal device 30 one by one in response to a request from the terminal device 30. When a user selects a hyperlink on a web page displayed, the service control unit 51 may transmit new HTML data corresponding to the hyperlink to the terminal device 30. A web page based on the new HTML data may be displayed on the terminal device 30. Since the service control unit 51 provides web pages stored in the system 10 one by one to a terminal device 30 in response to a user operation in this way, the user can receive a service on the basis of his or her operation through the functions of the service control unit 51.

A terminal device 30 can transmit various kinds of information used in the digital content providing service to the system 10 as appropriate by using the functions of browser software and/or an application. By storing various kinds of information received from a plurality of terminal devices 30, the service control unit 51 can control the digital content providing service on a user-by-user basis.

The information storage unit 52 may include a usage history management table 52a managing information concerning a history of usage of musical pieces by a user, a fan management table 52b managing information concerning a determination result made by the determination unit 53 as to whether the user is a fan of an artist, a musical piece management table 52c managing information concerning musical pieces, a feed information management table 52d managing information that can be provided to the terminal device 30 as feed information, a follow information management table 52e managing information concerning other users followed by the user, and a musical piece database 52f which may be a database of music data.

FIG. 4 illustrates an example of information that may be managed in the usage history management table 52a. As illustrated, the usage history management table 52a may associate a combination of a “user ID” identifying a user and a “musical piece ID” identifying a musical piece with information such as the “number of playbacks”, which may be the number of times the user has played back (used) the musical piece, and may manage these items of information as part of user information. The usage history management table 52a may be updated by the service control unit 51 every time the musical piece is played back by the terminal device 30 operated by the user. In the music distribution service provided by the system 10, when a user plays back a musical piece, the user can select one of three playback methods: “preview” in which only a part (for example a refrain) of music data is played back by streaming, “full listening” in which whole music data is played back by streaming, and “download” (purchase) in which whole music data is downloaded. In one embodiment, among the three playback methods, a playback of a musical piece by “preview” may be excluded from the “number of playbacks” counting, and a playback of a musical piece by “full listening” may be counted in the “number of playbacks” on completion of streaming of the whole music data, and a playback of a musical piece by “download” may be counted in the “number of playbacks” on completion of download of the music data. The methods for counting the “number of playbacks” are not limited to these but various methods can be employed For example, a playback of a musical piece by “full listening” may be counted in the “number of playbacks” when the music data has been streamed for a predetermined period of time or more (for example, for one minute or more) even if the streaming of the whole music data has not been completed; a playback of a musical piece by “download” may be counted as a predetermined number of playbacks (for example 10) in the “number of playbacks” when the downloading has been completed, on the assumption that playbacks of the music data on the terminal device 30 or a device other than the terminal device 30 after the downloading could not be managed by the system 10.

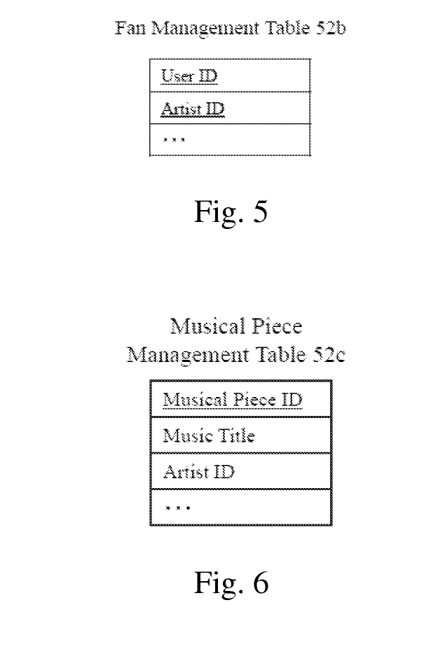

FIG. 5 illustrates an example of information that may be managed in the fan management table 52b. As illustrated, the fan management table 52b may manage information such as a combination of a “user ID” identifying a user and an “artist ID” identifying an artist of whom the user is a fan, as part of user information.

FIG. 6 illustrates an example of information that may be managed in the musical piece management table 52c. As illustrated, the musical piece management table 52c may manage information such as a “music title”, which may be the title of musical piece, and an “artist ID” identifying the artist of the musical piece in association with the “musical piece ID” identifying the musical piece. The musical piece management table 52c may manage information such as other metadata such as an image associated with the musical piece, an album name, and the release date. These items of information managed in the musical piece management table 52c can also be managed in the musical piece database 52f along with music data.

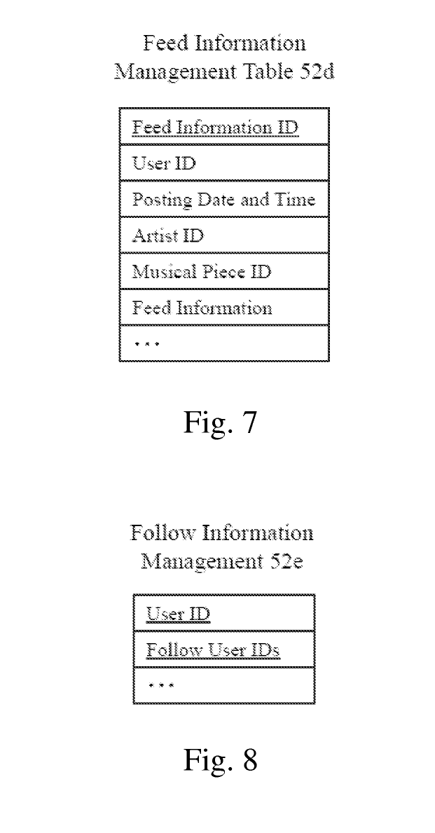

FIG. 7 illustrates an example of information that may be managed in the feed information management table 52d. As illustrated, the feed information management table 52d may associate and manage a “feed information ID” identifying each piece of feed information, such as a post or an article uploaded by a user, with information such as a “user ID” identifying the user who has posted the feed information, a “posting date and time” indicating the date and time on which the feed information has been posted, an “artist ID” identifying an artist relating to the feed information, a “musical piece ID” identifying a musical piece relating to the feed information, and “feed information” representing the content of the feed information. Feed information managed in the feed information management table 52d in one embodiment may include posts made by users and various articles provided by the operator of the system 10. Articles provided by the operator may be automatically added in conjunction with external web sites and databases. Information including links to such external web sites and databases may be set as “feed information”. Further, for articles provided by the operator, IDs identifying the sources of the articles may be set in the “user ID” and the dates and times on which the articles have been added may be set in the “posting date and time”.

FIG. 8 illustrates an example of information managed in the follow information management table 52e. As illustrated, the follow information management table 52e may manage information such as information concerning a combination of a “user ID” identifying a user and “follow user IDs” identifying other users whom the user is following.

In the musical piece database 52f, music data which can be provided to users may be stored in a file format such as AAC (Advanced Audio Coding) or WMA (Windows Media Audio). Note that the musical piece database 52f does not need to be provided in the system 10 but instead may be provided in another system, a server device, a database or the like which may be connected to the system 10 so that they can communicate with each other.

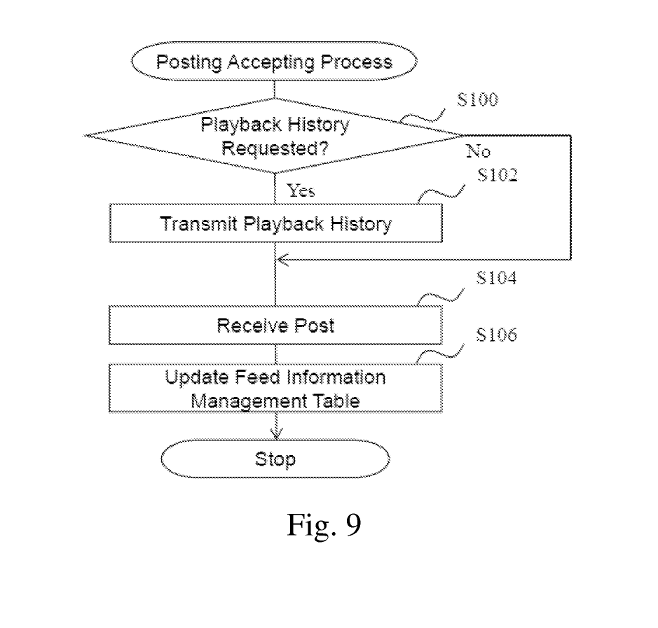

Operations of the system 10 as one embodiment of the present invention thus configured will now be described. Operations relating to posting by a user will be described first. FIG. 9 is a flowchart illustrating an exemplary posting accepting process executed by the system 10. For convenience, a posting accepting screen for accepting posts from users will be described first.

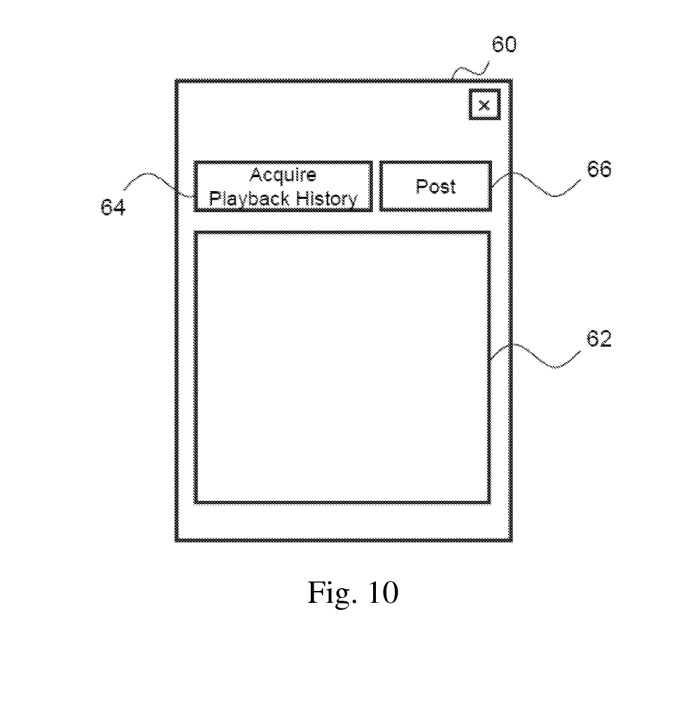

FIG. 10 is a diagram illustrating an exemplary posting accepting screen 60 displayed on a terminal device 30. As illustrated, the posting accepting screen 60 may include a post input area 62 for inputting a post, a playback history acquisition button 64 for acquiring a history of musical piece playbacks by a user, and a posting button 66 for transmitting the input post to the system 10. The post input area 62 may be designed to accept a post by a user by inputting text and/or attaching an image. When the user operating the terminal device 30 selects the posting button 66, the post input in the post input area 62 may be transmitted to the system 10.

Returning to the flowchart of FIG. 9, in the posting accepting process, when a musical piece playback history acquisition request is issued from a terminal device 30, a history of musical piece playback by the user operating the terminal device 30 may be transmitted to the terminal device 30 (steps S100 and S102). Specifically, when the playback history acquisition button 64 on the posting accepting screen 60 is selected by the user and a playback history acquisition request is transmitted from the terminal device 30, the playback history (a musical piece ID) of the user operating the terminal device 30 may be acquired from the usage history management table 52a, information such as associated “music titles” may be acquired from the musical piece

Attorney Docket No. 074530-0428255 management table 52c, and these items of information may be transmitted to the terminal device 30 as a playback history. When receiving the playback history, the terminal device 30 may display information concerning the musical pieces included in the user's playback history (for example the titles of the musical pieces and the name of the artists) as a list. When the user selects a desired musical piece from the musical pieces displayed on the list, information identifying the selected musical piece (for example the “musical piece ID”) may be input in the post input area 62. In other words, the user operating the terminal device 30 can select a desired musical piece from his or her playback history acquired by selecting the playback history acquisition button 64 to associate a post with the desired musical piece. Note that a post may be associated with a desired musical piece by a method other than inputting information identifying the musical piece in the post input area 62. For example, an area for setting a musical piece to be associated may be provided separately from the post input area 62. Also note that the user operating the terminal device 30 can input a post without associating the post with a musical piece.

When the post is received from the terminal device 30, the post received may be registered in the feed information management table 52d (steps S104 and S106) and then the posting accepting process may be ended. Specifically, in the information managed in the feed information management table 52d, the current date and time kept by the system 10 may be set in the “posting date and time”, the “artist ID” identifying the artist of the musical piece associated with the post may be set in the “artist ID”, the “musical piece ID” of the musical piece associated with the post may be set in the “musical piece ID”, and the post input in the post input area 62 of the posting accepting screen 60 may be set in the “feed information”.

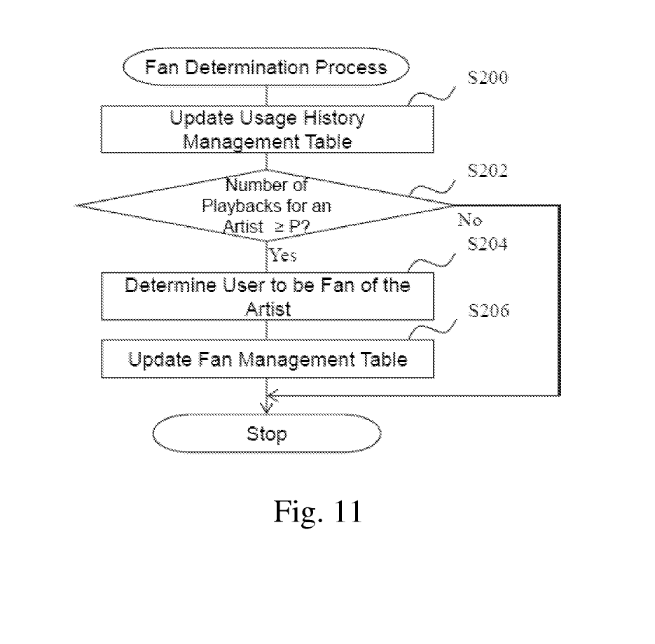

Operations relating to posting by a user have been described. Operations relating to determination of a fan of an artist will be described next. FIG. 11 is a flowchart illustrating an exemplary fan determination process which may be executed by the system 10. The fan determination process may be executed upon completion of the playback of a musical piece by a user of a terminal device 30. Here, the timing “upon completion of playback of a musical piece” may be the time when the playback of a musical piece has been completed in such a way that the playback is counted in the “number of playbacks” as described above. In one embodiment, for example, the timing may the time when streaming by “full listening” of whole music data has been completed or when downloading of music data by “download” has been completed

As illustrated in the figure, the fan determination process may start by updating the usage history management table 52a for completed playback of a musical piece (step S200). Specifically, a record corresponding to a combination of the “user ID” of the user of the terminal device 30 and the “musical piece ID” of the musical piece that has been completely played back may be updated. More specifically, when the user has played back the musical piece for the first time, such a record may be newly created, a value “1” may be set in the “number of playbacks”; when the user has been played back the musical piece in the past, “1” may be added to the “number of playbacks”.

Then, the numbers of playbacks of all of the musical pieces of the artist of the musical piece just played back may be added together and, if the sum of the numbers of the playbacks is greater than or equal to a predetermined number of playbacks P (for example 5), the user may be determined to be a fan of the artist (steps S202 and S204). Specifically, the sum of the numbers of playbacks may be determined as follows: the musical piece management table 52c may be looked up to find all of the musical pieces of the artist of the musical piece just played back, the usage history management table 52a may be looked up to determine the numbers of playbacks of all of the found musical pieces by the user, and the determined numbers of playbacks may be added together.

When the user is determined to be a fan of the artist in this way, the determination result may be registered in the fan management table 52b (step S206) and then the fan determination process may be ended. Specifically, the combination of the “user ID” of the user determined to be a fan and the “artist ID” of the artist may be registered in the fan management table 52b. Note that in addition to the determination as to whether or not the user is a fan made as a result of the fan determination process, the user may be allowed to register an artist of whom the user is a fan. In that case, the user operating the terminal device 30 may transmit information about the artist of whom the user is a fan via an appropriate display screen and the system 10 may register the artist in the fan management table 52b on the basis of the transmitted information.

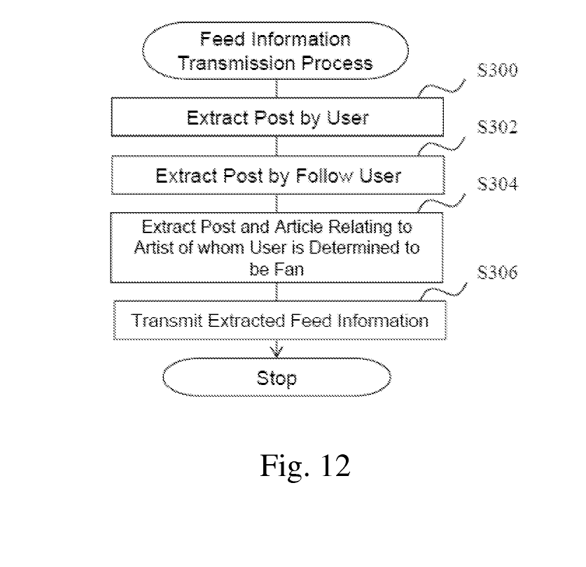

Operations relating to determination of a fan of an artist have been described. Operations for transmitting feed information to a terminal device 30 will be described next. FIG. 12 is a flowchart illustrating an exemplary feed information transmission process executed by the system 10. The feed information transmission process may be executed when a request to display a screen including feed information is received from a terminal device 30. As illustrated in the figure, the feed information transmission process may start by extracting feed information posted by a user operating the terminal device 30 from the feed information management table 52d (step S300). Specifically, a record associated with the “user ID” of the user of the terminal device 30 in the feed information management table 52d may be extracted.

Then, feed information posted by follow users following the user operating the terminal device 30 may be extracted from the feed information management table 52d (step S302). Specifically, the follow information management table 52e may be looked up to find the “user IDs” (“follow user IDs”) of the follow users following the user operating the terminal device 30 and records in which the found “user IDs” of the follow users are set in the “user ID” in the feed information management table 52d may be extracted.

Then, feed information (posts and various articles) relating to the artist of whom the user operating the terminal device 30 has been determined to be a fan may be extracted (step S304). Specifically, the fan management table 52b may be looked up to find the “artist ID” of the artist of whom the user operating the terminal device 30 has been determined to be a fan and records in which the found “artist ID” of the artist are set in the “artist ID” in the feed information management table 52d may be extracted.

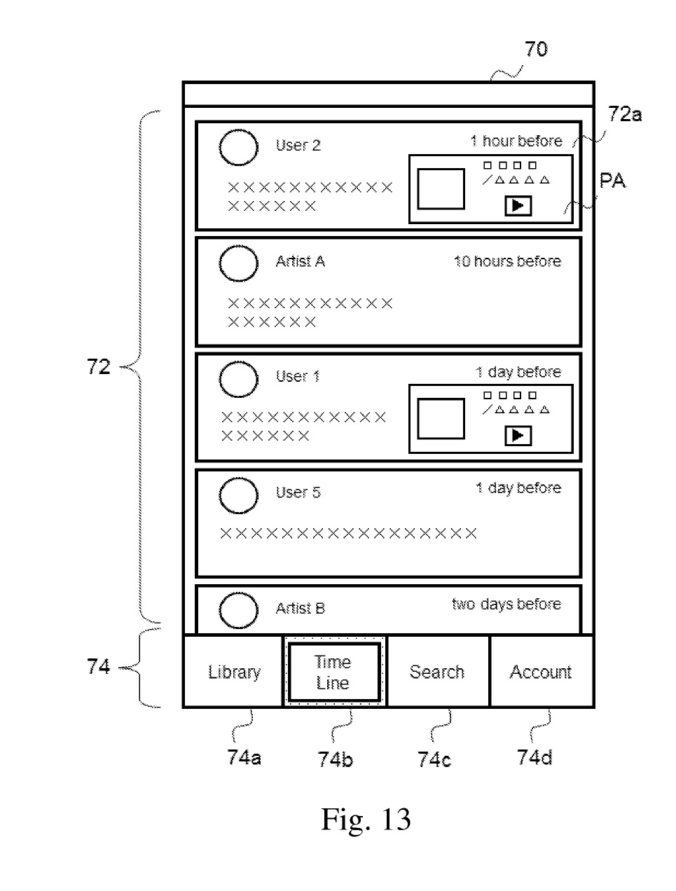

Once the feed information posted by the user operating the terminal device 30, the feed information posted by the follow users, and the feed information relating to the artist of whom the user has been determined to be a fan have been thus extracted from the feed information managed in the feed information management table 52d, screen data including these pieces of feed information may be generated and transmitted to the terminal device 30 (step S306), then the feed information transmission process may be ended. FIG. 13 is a diagram illustrating one display mode of a main screen 70, which is an exemplary screen including feed information and displayed on a terminal device 30. The main screen 70 may be a basic screen for receiving a music distribution service and may include a main display part 72 and a display switching command part 74 for switching between items displayed on the main display part 72, as illustrated in the figure. The display switching command part 74 may include a library button 74a for displaying musical pieces that can be provided by the system 10, a timeline button 74b for displaying feed information, a search button 74c for searching for an artist page containing information concerning a particular artist or searching for other users, and an account button 74d for displaying basic information of the user. In the example in FIG. 13, the timeline button 74b is selected in the display switching command part 74 and feed information is displayed in list form in the main display part 72. The feed information may be the feed information extracted and transmitted to the terminal device 30 by the feed information transmission process described above. The feed information may be sorted in descending order (i.e. in the reverse chronological order) of posting date and time (managed in “posting date and time” in the feed information management table 52d), for example. As illustrated, in each piece of the feed information displayed on the main screen 70, an image and a name identifying the user who has posted the feed information or the source of each of various kinds of articles may be displayed at the upper left corner, the elapsed time or days since the piece of feed information was posted or registered may be displayed at the upper right corner, and the body of the post or the article (text and/or image) may be displayed in the lower half of the piece of feed information. Additionally, if the piece of feed information is associated with a musical piece, a music playback area PA for playing back the musical piece may be displayed as illustrated in feed information 72a. Basic information about the musical piece (an image associated with the musical piece and the title of the musical piece, the name of the artist, and the like) and a playback button may be displayed in the music playback area PA. When the user operating the terminal device 30 selects the playback button, a music playback screen 80 for playing back the corresponding musical piece may be popped up.

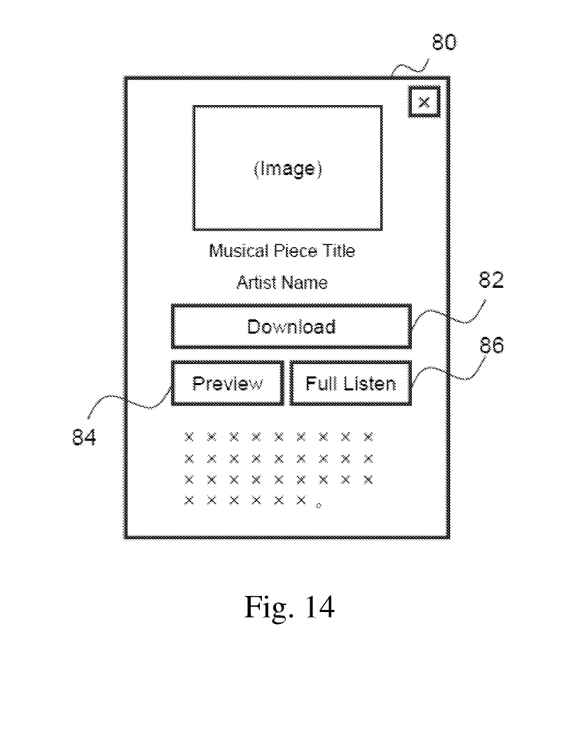

FIG. 14 is a diagram illustrating an example of the music playback screen 80. As illustrated, basic information about a musical piece is displayed in the upper part of the music playback screen 80, a purchase button 82 to “download” (purchase) the musical piece, a preview button 84 to “preview” the musical piece, and a full listening button 86 to “fully listen” to the musical piece are in the lower part of the screen. When the user operating the terminal device 30 selects the purchase button 82, whole music data of the corresponding musical piece stored in the musical piece database 52f may be downloaded; when the user selects the preview button 84, a part of the music data may be streamed; when the user selects the full listening button 86, the whole music data may be streamed. In this way, the user operating the terminal device 30 can play back the musical piece from a piece of the feed information displayed on the main screen 70, for example feed information posted by a follow user, through the music playback screen 80. Note that when the user selects the purchase button (“Want”) 82, the musical piece may be placed on an add-to-download (purchase) list, instead of immediately downloading the musical piece. In that case, music data may be downloaded through a separately provided download screen on the basis of the list.

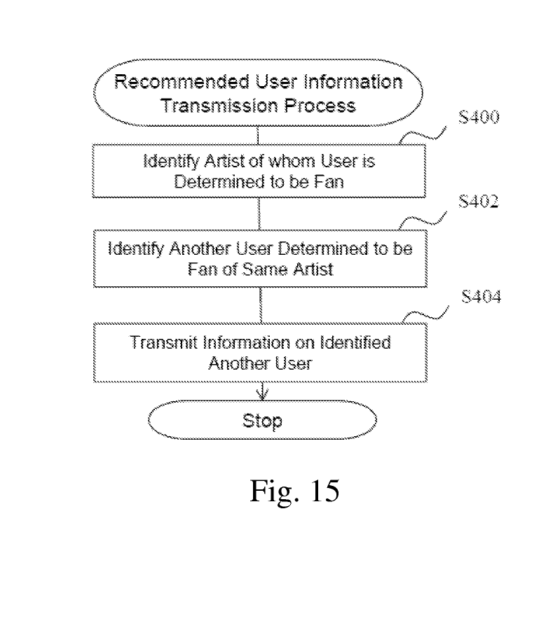

Operations for transmitting feed information to a terminal device 30 have been described. Operations relating to recommendation of users to another will be described next. FIG. 15 is a flowchart illustrating an exemplary recommended user information transmission process executed by the system 10. The recommended user information transmission process may be executed when a request to display a screen including recommended user information is received from a terminal device 30. In the recommended user information transmission process, first an artist of whom the user operating the terminal device 30 is determined to be a fan may be identified as illustrated in the figure (step S400). Specifically, an “artist ID” registered in the fan management table 52b in combination with the “user ID” of the user of the terminal device 30 may be identified.

Then, another user determined to be a fan of the same artist of whom the user operating the terminal device 30 has been determined to be a fan may be identified (step S402). Specifically, a “user ID” registered in the fan management table 52b in combination with the “artist ID” of the artist of whom the user of the terminal device 30 has been determined to be a fan may be identified.

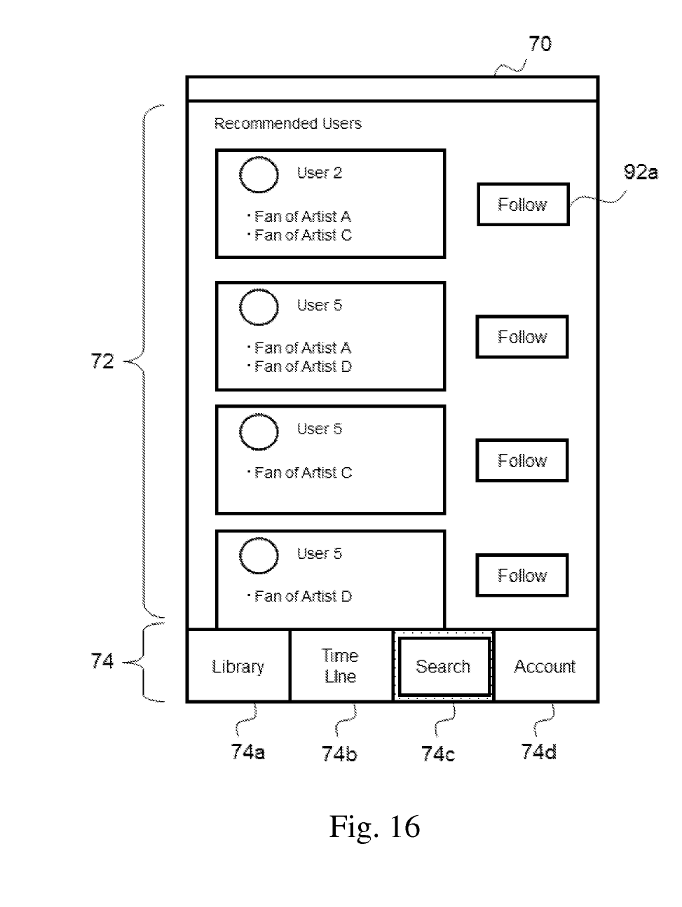

Screen data including a screen including information about the identified other user may be generated and transmitted to the terminal device 30 (step S404), then the recommended user information transmission process may be ended. FIG. 16 is a diagram illustrating one display mode of the main screen 70, which is an example of the screen including recommended user information displayed on a terminal device 30. In the exemplary main screen 70, the search button 74c in the display switching command part 74 is selected and information about recommended users is displayed in list form in the main display part 72. The information about the recommended users may be the information that has been extracted and transmitted to the terminal device 30 by the recommended user information transmission process described above. In one embodiment, the recommended user information may be sorted in descending order of the number of artists of whom both of the user operating the terminal device 30 and each of the recommended users have been determined to be fans (i.e. in descending order of the number of artists of whom both of the user of the terminal device 30 and each of the recommended users are fan). As illustrated, the information about each recommended user displayed on the main screen 70 may include an image and a name that identify the recommended user, displayed in the upper part, and a display of information about the artists or artist of whom both of the user operating the terminal device 30 and the user recommended user have been determined to be fans, displayed in the lower part. As illustrated, a follow button 92a may be displayed to the right of the information about each recommended user. When the user operating the terminal device 30 selects the follow button 92a, the user can follow the corresponding recommended user. Specifically, the follow information management table 52e may be updated so that the corresponding recommended user becomes a follow user of the user operating the terminal device 30. Note that after other users determined to be fans of the same artist of whom the user operating the terminal device 30 was determined to be a fan have been identified at step S402 of the recommended user information transmission process, those users who have been determined to be fans of the same artists as the user is that are as many as a predetermined number (for example 5) or more may be identified and selected as recommended users from among the other users. Alternatively, other users determined to be fans of all of the artists of whom the user operating the terminal device 30 has been determined to be a fan may be selected as the recommended users.

The system 10 in one embodiment described above determines a user who has played back one or more musical pieces (digital contents) of the same artist (classification information) a predetermined number of times P or more to be a fan (specific user) of the artist. Thus, an artist liked by a user can be readily identified in circumstances where the user uses a wide variety of musical pieces and user's preferences in music can be properly estimated.

Further, the system 10 in one embodiment is capable of extracting feed information (a display content) relating to an artist of whom a user has been determined to be a fan and transmitting the feed information to a terminal device 30 operated by the user. Thus, feed information that is suited to the user's preferences in music can be transmitted to the user.

Moreover, the system 10 in one embodiment chooses users determined to be fans of the same artist as the artist of whom a user has been determined to be a fan as recommended users and transmits information about the chosen recommended users to a terminal device 30 operated by the user. Thus, information about recommended users suited to the user's preferences in music can be transmitted to the user.

While a user who has played back musical pieces of the same artist a predetermined number of times or more is determined to be a fan of the artist in the system 10 in one embodiment, the condition for determining a user to be a fan is not limited to this. Any other conditions concerning a history of playbacks of musical pieces (usage history) may be used For example, a user who has played back a musical piece for a predetermined amount of time or more in total may be determined to be a fan, or a user who has played back a predetermined number of musical pieces or more may be determined to be a fan, or a user who has played back a musical piece a predetermined number of days or more in total may be determined to be a fan.

While “artist” is used as classification information for classifying musical pieces in the system 10 in one embodiment, other information may be used as the classification information. For example, a genre or label of music may be used as the classification information and a user who has played back musical pieces of the same genre or label a predetermined number of times or more may be determined to be a specific user of the genre or label. Any of various kinds of information, including information other than artist, genre and label, that can be used for classifying musical pieces can be used as the classification information.

While one embodiment has been described in the context of a service providing musical pieces, which are an example of digital contents, the processes and procedures described herein are also applicable to systems that provide any of various kinds of digital contents, including videos, electronic books, and games.

The processes and procedures described and illustrated herein may also be implemented by software, hardware, or any combination thereof other than those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

What is claimed is:

1. A system connected through a communication network to a plurality of terminal devices each operated by a respective user, the system being capable of providing a plurality of digital contents to the users, the system comprising:
an information storage device configured to store at least user information concerning the users, including a history of usage of the digital contents by each of the users, digital content information concerning the digital contents including classification information for classifying the digital contents, and a plurality of display contents displayable on the terminal devices; and
one or more processors capable of executing a predetermined program,
wherein the predetermined program comprises:
a determination module configured to determine a user satisfying a predetermined condition concerning the history of usage of one or more digital contents classified under a same piece of the classification information, to be a specific user for the piece of the classification information;
a user information updating module configured to store a determination result made by the determination module in the information storage device as a part of the user information;
an accepting module configured to accept display contents associated with the digital contents from the terminal device and store the display contents in the information storage device in association with the digital contents; and
a display content transmitting module configured to, in response to a request from the terminal device, extract one or more display contents to be presented to a user operating the terminal device from among the plurality of display contents on the basis of an extraction condition for extracting a display content to be presented to the user from among the plurality of display contents, and transmit the one or more display contents to the terminal device, the extraction condition including at least a condition that a display content relating to the piece of the classification information for which the user has been determined to be the specific user is to be extracted,
wherein the display content relating to the piece of the classification information includes a display content relating to a digital content classified under the piece of the classification information.

2. The system according to claim 1, wherein the predetermined condition includes at least a condition that the sum of the numbers of times of usage of the one or more digital contents classified under the same piece of the classification information is greater than or equal to a predetermined number of times.

3. The system according to claim 1,
wherein the accepting module is configured to accept the display contents from the terminal device and stores the display contents in the information storage device in association with the user operating the terminal device; and
the extraction condition includes a condition that the display content associated with the user is to be extracted.

4. The system according to claim 1,
wherein the user information includes related user information concerning a combination of the user and one or more other users selected by the user; and
the extraction condition includes a condition that the display contents associated with other users combined with the user by the related user information are to be extracted.

5. The system according to claim 1, wherein the predetermined program comprises a recommended user information transmitting module configured to choose, as recommended users to be recommended to the user, some or all of other users determined to be the specific users for the same piece of the classification information as the piece of the classification information for which the user has been determined to be the specific user, and transmit information concerning the chosen recommended users to the terminal device operated by the user.

6. The system according to claim 5, wherein the recommended user information transmitting module is configured to choose the recommended users on the basis of at least the number of the pieces of the classification information for which both the user and the other users have been determined to be the specific users.

7. The system according to claim 1,
wherein the digital contents include at least one of a musical piece, a video, an electronic book and a game; and
the classification information includes a person, a group, a company or other entities relating to the digital contents.

8. A system connected through a communication network to a plurality of terminal devices each operated by a respective user, the system being capable of providing a plurality of digital contents to the users, the system comprising:
an information storage unit configured to store at least user information concerning the users, including a history of usage of the digital contents by each of the users, digital content information concerning the digital contents including classification information for classifying the digital contents, and a plurality of display contents displayable on the terminal devices;
a determination unit configured to determine a user satisfying a predetermined condition concerning the history of usage of one or more digital contents classified under a same piece of the classification information, to be a specific user for the piece of the classification information;
a user information updating unit configured to store a determination result made by the determination unit in the information storage unit as a part of the user information;
an accepting unit configured to accept display contents associated with the digital contents from the terminal device and store the display contents in the information storage unit in association with the digital contents; and
a display content transmitting unit configured to, in response to a request from the terminal device, extract one or more display contents to be presented to a user operating the terminal device from among the plurality of display contents on the basis of an extraction condition for extracting a display content to be presented to the user from among the plurality of display contents, and transmit the one or more display contents to the terminal device, the extraction condition including at least a condition that a display content relating to the piece of the classification information for which the user has been determined to be the specific user is to be extracted,
wherein the display content relating to the piece of the classification information includes a display content relating to a digital content classified under the piece of the classification information.

9. A method for providing a plurality of digital contents to a plurality of users by using a system connected through a communication network to a plurality of terminal devices each operated by respective one of the plurality of users, the system comprising an information storage device for storing information, the method comprising:
storing, in the information storage device, at least user information concerning the users, including a history of usage of the digital contents by each of the users, digital content information concerning the digital contents including classification information for classifying the digital contents, and a plurality of display contents displayable on the terminal devices;
determining a user satisfying a predetermined condition concerning the history of usage of one or more digital contents classified under a same piece of the classification information, to be a specific user for the piece of the classification information;
storing the determination result in the information storage device as a part of the user information;
accepting display contents associated with the digital contents from the terminal device and storing the display contents in the information storage device in association with the digital contents; and
in response to a request from the terminal device, extracting one or more display contents to be presented to a user operating the terminal device from among the plurality of display contents on the basis of an extraction condition for extracting a display content to be presented to the user from among the plurality of display contents, and transmitting the one or more display contents to the terminal device, the extraction condition including at least a condition that a display content relating to the piece of the classification information for which the user has been determined to be the specific user is to be extracted,
wherein the display content relating to the piece of the classification information includes a display content relating to a digital content classified under the piece of the classification information.
